(19) United States
(12) Patent Application Publication
(10) Pub. No.: US 2006/0004708 A1
(43) Pub. Date: Jan. 5, 2006

(54) Predefined search queries for a search engine

(76) Inventors: Joachim P. Hartmann, St. Ingbert (DE); Bernd Reimann, St. Lambert (CA); Ralf Witt, Eppelborn (DE); Wolfgang Sattler, Kirkel (DE)

Correspondence Address: FISH & RICHARDSON, P.C., PO BOX 1022, MINNEAPOLIS, MN, 55440-1022, US

(21) Appl. No.: 10/862,016

(22) Filed: Jun. 4, 2004

(51) Int. Cl. G06F 17/30

(52) U.S. Cl. 707/3

(57) ABSTRACT

In a computer system, predefined search queries may be retrieved from a file. Each of the predefined search queries may be used by a search engine to search a data repository. User-understandable representations of the predefined search queries are displayed on a graphical user interface for user selection. A user input is received upon a user selecting at least one of the displayed user-understandable representations. Upon receiving the user input, the search engine is caused to perform the selected predefined search query in the data repository. The user-understandable representations may be items in one or more drop down list boxes. A results display declaration may specify the search result attributes that are to be displayed, and their formatting.

### TECHNICAL FIELD

This description relates to displaying user-understandable representations of predefined search queries for a search engine.

### BACKGROUND

Many computer systems include one or more data repository. The repository may be a structured or unstructured database of information. For example, a computer system for customer relationship management (CRM) functions has at least one data repository with the information relating to customers, products, sales orders, returns, and other business aspects.

Most data repositories can be searched using a search engine. Some search engines periodically compile lists (or indexes) of the repository contents so that the lists can be used to search the repository. Search engines typically are provided with a graphical user interface (GUI) that lets the user formulate queries. Some search engines require users to have expert knowledge in formulating database queries and may be capable of searching for the presence of a user-entered word.

Repositories may include documents of different types. If the user of such a system wants to retrieve some or all documents of a particular type, the user may have to learn an internal identifier that is associated with the sought document type, and enter that identifier in a suitable search query to perform the desired search.

Existing search engines may let the user combine several search criteria to restrict the search. However, the user may need to have expert knowledge in creating search queries to successfully combine search criteria that are related to each other. For example, use of a search engine may require skills in using Boolean operators between search terms. Accordingly, it may be difficult for a user to retrieve all documents that have a common characteristic.

### SUMMARY

The invention relates to predefined search queries for a search engine.

In a first general aspect, a method comprises retrieving predefined search queries from a file in a computer system, each of which predefined search queries can be used by a search engine to search a data repository. User-understandable representations of the predefined search queries are displayed on a graphical user interface for user selection. A user input is received upon a user selecting at least one of the displayed user-understandable representations. Upon receiving the user input, the search engine is caused to perform the selected predefined search query in the data repository.

In selected embodiments, each of the predefined search queries is designed for retrieving a document stored in the data repository that has a predefined document type. The data repository may include multiple document types, and retrieving the predefined search queries may comprise accessing search query declarations stored in the file, each of the search query declarations being associated with one of the document types.

In selected embodiments, there is displayed in the graphical user interface results of the selected predefined search query in a format specified by a results display declaration in the file. The results display declaration may be retrieved from the file upon receiving the user input. The results display declaration may indicate that specific attributes of the results are to be displayed in the graphical user interface. The search engine may return only the specific attributes. If the search engine returns the specific attributes and other attributes upon performing the selected predefined query, the method may comprise removing the other attributes before displaying the results.

In selected embodiments, the user-understandable representations are displayed to the user as a guide to the predefined search queries. The user may select one of the user-understandable representations by typing the selected user-understandable representation into a field on the graphical user interface.

In a second general aspect, a graphical user interface for user selection of a predefined search query comprises a search query selection area in which user-understandable representations of predefined search queries can be displayed, which predefined search queries can be performed by a search engine in a data repository, wherein display of at least one of the user-understandable representations is dependent upon user selection of another of the user-understandable representations.

In selected embodiments, selecting the at least one user-understandable representation adds a restriction to the predefined search query of the other user-understandable representation. The at least one user-understandable representation and the other user-understandable representation may be drop down list box entries.

Advantages of the systems and techniques described herein may include any or all of the following: Providing more user-friendly data repository searching; providing more user-friendly document retrieval; providing a better visual presentation of predefined search queries; improving presentation of search criteria that can be combined with each other; improving display of dependent search queries; providing easy generation of new search queries; and providing a more-user-friendly GUI.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system that includes predefined search queries for a search engine;

FIG. 2 is a block diagram with an exemplary server device for the system shown in FIG. 1;

FIGS. 3A-C show user-understandable search query representations that can be displayed by the system shown in FIG. 1;

FIG. 4 is a flow chart of an embodiment of an inventive method; and

FIG. 5 is a block diagram of a general computer system.

Like reference numerals in the various drawings indicate like elements.

### DETAILED DESCRIPTION

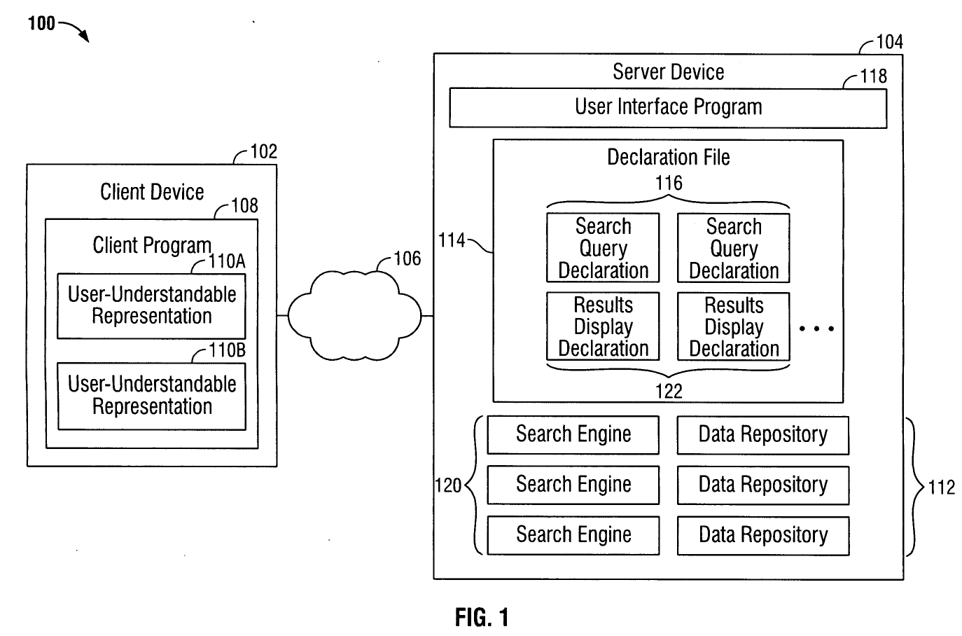

FIG. 1 shows a system 100 that includes a client device 102 connected to a server device 104 through any kind of computer network 106. For example, the client device 102 is a personal computer and the network 106 is the Internet. The client device may include a client program 108, for example a browser program such as Microsoft Internet Explorer. As will be described below, the system 100 displays one or more user-understandable representation (UUR) 110 on the client device 102. Upon a user selecting one or more of the UUR, an associated search query will be performed in one or more data repository 112.

The server device has stored therein a file 114 that it accesses to generate a display on the client device. Particularly, the file 114 may include one or more search query declarations 116. A user interface program 118 includes instructions for accessing the file 114. For example, the program 118 causes the server device to access the file 114 to generate a screen that can be sent to the client device for display. In some implementations, the file 114 is a file containing extensible markup language (XML) instructions.

By accessing a search query declaration 116 in the file 114, the system 100 can retrieve one or more predefined search queries. A UUR 110 of any such retrieved search query can be displayed on the client device. The UUR may be retrieved from the search query declaration 116 together with the predefined query, or the UUR may be part of a preconfigured library available to the program 118 such that the UUR can be matched with an associated search query.

The user can initiate a query by selecting any of the displayed UURs. Such a selection causes a user input to the server device. Upon receiving the user input, the server device, which may be executing an instruction from the program 118, may cause the selected search query to be performed in one or more of the data repositories 112. Particularly, the server device may include at least one search engine 120 that is configured to search the data repository. Accordingly, the selected predefined search query may be passed to one of the search engines 120 to be performed.

Results of the repository search are passed to the program 118 to generate a screen for display on the client device. Particularly, the file 114 may include one or more results display declarations 122 that specify how results are to be displayed. The results display declaration 122 may specify what attributes of the obtained results are displayed and how to format the results. The results display declarations 122 may be associated with particular search query declarations such that user selection of a particular search query determines how to display the search results.

Accordingly, one advantage is that the file 114 can include search queries and results display declarations for any queries that should be available to the user.

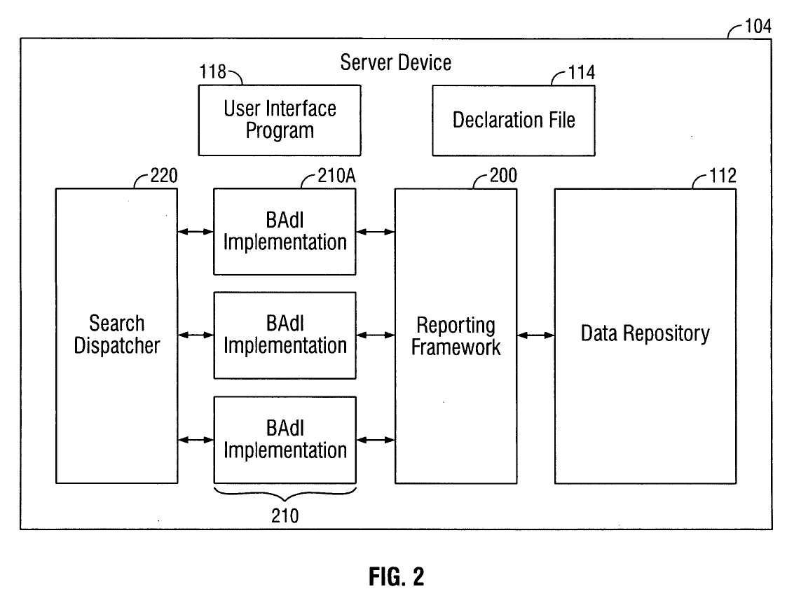

FIG. 2 is an example of the system 100 where only the server device 104 is shown for clarity. Here, the computer system includes a reporting framework 200 that interacts with one or more of the data repositories 112 to extract information. For example, the reporting framework may be configured to retrieve documents from the repository for display to a user.

The system also may include one or more mapping programs that map selected search queries to the reporting framework 200. Here, the mapping program is a Business Add-In (BAdl) program. There may be one or more BAdl implementations 210 representing different document types that may exist in the data repository. BAdl programs may be configured according to the BAdl technology developed by SAP AG located in Walldorf (Baden), Germany. For example, a BAdl program can be used as a “customer exit” to a delivered system by which the customer can define unique functionality that is not initially part of the system. Accordingly, the search engine 120 may include at least one BAdl implementation and at least part of the reporting framework 200.

The following is an example of an operation of the above described components. The server device receives an input upon the user selecting a UUR on the client device. The UUR is associated with a search query that the server device obtains from the file 114. For example, the search query calls for documents of a particular type to be retrieved. Here, one of the BAdl implementations 210, say a first BAdl implementation 210A, is associated with that document type. The search query is passed to the BAdl implementation 210A which maps the query to the reporting framework 200. That is, the BAdl implementation 210A may include predefined commands that can cause the reporting framework to retrieve documents according to a particular search query that the BAdl implementation receives. The reporting framework, in turn, may retrieve one or more documents from the data repository 112 that match the query. The search results are passed to the client device for display.

In some implementations, the server device 104 may include a search dispatcher 220 that passes the selected predefined search query to the BAdl implementation with which it is associated. The search dispatcher may pass the search query to a proper one of the BAdl implementations based on what document type the search query seeks. In some implementations, the search dispatcher uses filter criteria to identify the right BAdl implementation. For example, a document type may be a filter criterion used by the search dispatcher. In implementations where the file 114 includes results display declarations, the search dispatcher may pass such a declaration to the proper BAdl implementation to be included in the call to the reporting framework.

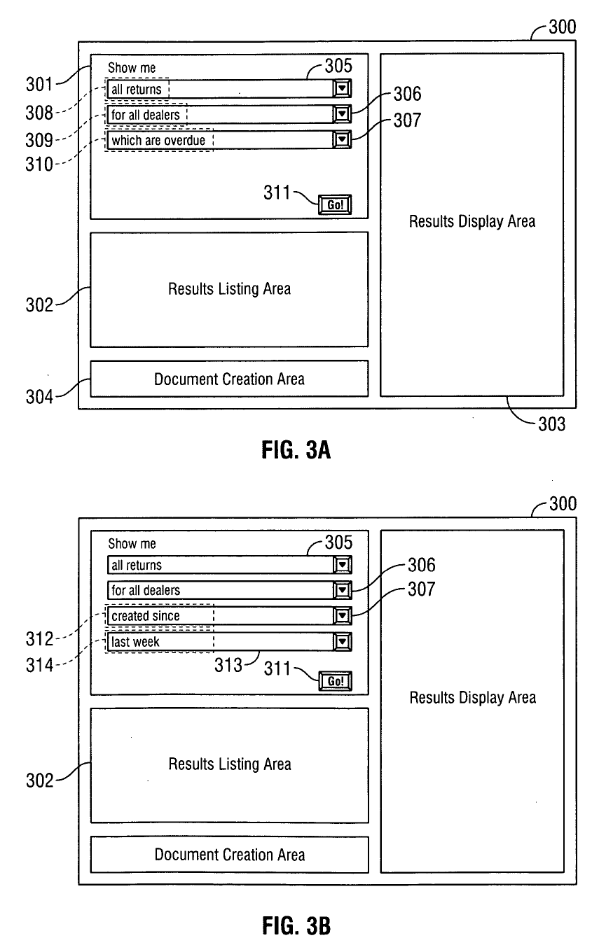

An example of how the system 100 may be implemented and used will now be described with reference also to FIGS. 3A-C, which show a GUI 300 that can be displayed on the client device 102. Particularly, the GUI 300 may be displayed using the client program 108.

In this example, the system 100 is used by car manufacturers and the dealers associated with them. That is, the server device 104 may be used by the manufacturer for certain aspects of its business, such as managing the manufacture of spare car parts and the distribution of such parts to dealers and others. The dealer(s), in turn, may use one or more of client device 102 to manage their ordering, receipt, invoicing and returns of spare parts. That is, a dealer may use the client device to order spare parts, check status of ordered parts, check invoicing for ordered parts, or submit return requests for ordered parts that the dealer does not want to keep in inventory.

The GUI 300 includes a search query selection area 301 where the user can select a search query to be performed. The GUI includes a results listing area 302 wherein one or more documents that are responsive to the query can be listed. Upon the user selecting a document listed in the area 302, the selected document is displayed in results display area 303. The GUI may include a document creation area 304 wherein the user can select and create a particular document type, such as a claim document or a return document, to be created. After the user enters the relevant information in the created document, it can be submitted to the server device 108, for receipt by the manufacturer, for example.

The search query selection area 301 currently includes respective drop down list boxes 305, 306 and 307. By making selections in one or more of the boxes 305-307 the user can formulate a search query for retrieving documents. Moreover, making a selection in a drop down list box may cause fewer or more boxes to be displayed in the area 301, as will be described below.

Each of the drop down list boxes may include one or more UUR 110. For example, the box 305 includes a UUR 308 which states “all returns.” Here, the box 305 includes queries that determine what scope of document types will be retrieved, and the presently selected UUR 308 indicates that the query concerns all documents that are “returns”; that is, all documents that correspond to returns of spare parts from the dealer. Accordingly, the UUR 308 is associated with a predefined search query that identifies all return documents.

The box 306, in turn, determines the range of dealers that the query will concern. Here, there is selected in the box 306 a UUR 309 which states “for all dealers,” meaning that return documents from all dealers will be considered for this query. Accordingly, the UUR 309 is associated with a predefined search query that identifies documents for all dealers. For example, the system 100 can be configured so that various groups of dealerships, such as those that are under common ownership, are considered a family of dealers in the system. The system may grant permission for individual dealers that are members of such a family to see the documents generated or owned by other members. Hence, box 306 includes the UUR 309 that applies the query to “all dealers.”

Thus, the boxes 305 and 306 specify that the query concerns all returns for all dealers. In box 307, the user can specify which of the documents defined by boxes 305 and 306 that the query should identify. Here, the box 307 includes a UUR 310 which states that the query seeks the queries “which are overdue.” Accordingly, the UUR 310 is associated with a predefined search query that identifies overdue returns.

If the user wishes to have the search engine perform the presently selected query, the user may select the “Go!” button 311. Assume, however, that the user wishes to run another query. The user may then change the selection in any of boxes 305-307 to formulate a different query. Here, the user is not interested in overdue returns, but rather in recently created returns. The user therefore selects another UUR in the box 310, for example by causing the box to display its menu and selecting another item listed on the menu.

The selection of a different UUR may change the appearance of the GUI 300 to that shown in FIG. 3B. Now, the box 307 shows that the user has selected a UUR 312 that states “created since.” The UUR 312 is associated with a predefined search query that identifies documents created since a specified date. Moreover, a drop down list box 313 now is displayed below the box 307. The display of the box 313 depends on user selection of the UUR 312 in box 307. In the box 313, the user can select between different predefined time intervals, such as the presently selected UUR 314 which states “last week,” which in combination with the UUR 312 means that the query will identify documents created since last week. Accordingly, the UUR 314 is associated with a predefined search query that identifies documents created since last week.

The user now selects the “Go!” button 311 to run the predefined search query associated with the user's selection of UURs in the boxes 305-307 and 314. The client device 102 sends the user input to the server device 104, where the search query is passed to at least one search engine 120. For example, this particular query relates to returns and should be performed in the repository where return documents are stored. Accordingly, the search query may be sent to the one of the search engines that is associated with that data repository.

The predefined search query is performed by the search engine that receives it. If the search engine identifies one or more documents as responsive to the query, the engine returns attribute(s) of the document(s) as a search result. The server device sends the search result to the client device for display in the results listing area 302.

FIG. 3C shows the GUI 300 with the results displayed in the area 302. The area 302 includes a header 315 that identifies the displayed attributes of the search results. In this example, the attributes are: return number (first column), date of the return document (second column) and status (third column). The listed return numbers are links that the user can activate to have the selected document displayed in the results display area 303.

The displayed attributes are those specified by the results display declaration 122. Moreover, the declaration may specify the formatting of the displayed results, such as the configuration of the return numbers as links to the identified documents. The results display declaration may therefore be accessed and forwarded to the search engine performing the query. In some implementations, the search engine returns only the attributes that the declaration calls for. In other words, the search engine “understands” the results display declaration and produces only responsive information. In other implementations, the search engine is not configured to handle the results display declaration and returns a standard set of attributes for the identified documents. This standard set may include both the specific attributes that are to be displayed and other attributes. In such implementations, the other attributes may be removed from the search results before display. For example, the program 118 may use the results display declaration to filter out the irrelevant values when generating the screen to be displayed on the client device.

The presently described example does not show all UURs that can be selected in the GUI 300. For example, the box 305 can include the following UURs:

TABLE 1

all claims
claims due to
all returns
returns of type
all core credit requests
core credit requests of type

Upon user selection of the “all claims” or “all returns” UUR in the box 305, to name just two examples, the box 306 may include the following UURs:

TABLE 2

for all dealers
name of specific dealer #1
name of specific dealer #2
name of specific dealer #3

Accordingly, the user can select a specific dealer or have the query encompass all dealerships.

If, in contrast, the user selects the “returns of type” UUR in the box 305, the box 306 may include the following UURs:

TABLE 3

rapid
special
warranty
termination

Accordingly, the display of some UURs (e.g., those in Table 3) may be dependent on user selection of one or more specific UUR (e.g., the “returns of type” UUR in Table 1. The UURs shown in Tables 1-3 are only examples. Different UURs, and different numbers of UURs, may be used.

In other implementations, the predefined search queries may be initiated other than by drop down list boxes, such as by using other input controls for the UURs. For example, the UUR 110A shown in FIG. 1 may be a word or phrase that the user types in a text entry field in the program 108. That is, the UURs may be displayed to the user as a guide to what search queries can be performed, and the user can select one of the UURs by typing it into the field.

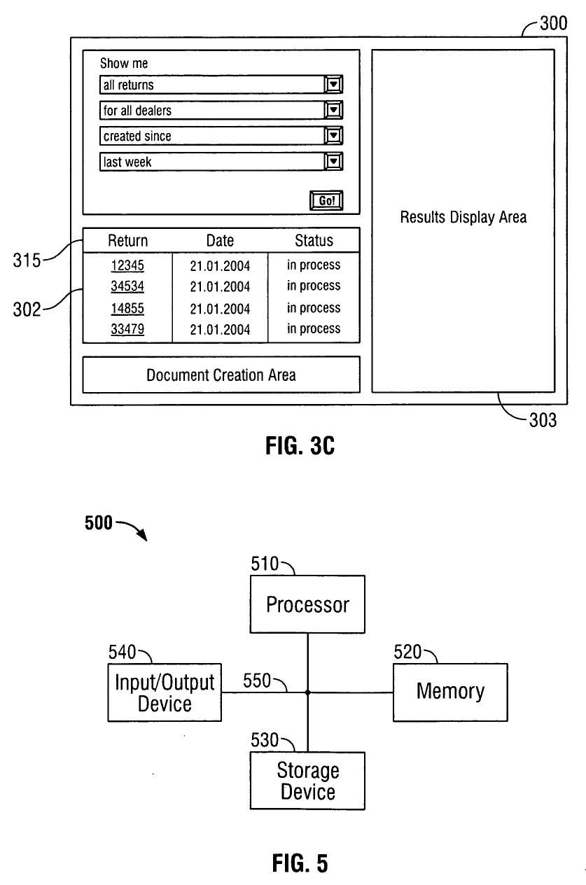

FIG. 4 is a flow chart of a method 400. The method 400 may be performed in the system 100. For example, a computer program product may include instructions that cause a processor to perform operations comprising the steps of the method 400. The method 400 includes the following steps:

Retrieving, in step 410, predefined search queries from a file in a computer system. The predefined search queries can be used by a search engine to search a data repository. For example, the server device 104 can access the search query declaration(s) 116 to retrieve search queries. The file 114 where the declarations 116 are stored may be an XML file.

Displaying, in step 420, UURs of the predefined search queries on a GUI for user selection. For example, any or all of the user-selectable UURs 308-310, 312 and 314 may be displayed in the GUI 300.

Receiving, in step 430, a user input upon a user selecting at least one of the displayed UURs. For example, the user may select the UURs 308-310 to run a query for all overdue returns from all dealers. As another example, the user may select the UURs 308, 309, 312 and 314 to run a query for all returns created since last week for all dealers. The user input may be generated upon the user selecting the button 311.

Upon receiving the user input, causing, in step 440, the search engine to perform the selected predefined search query in the data repository. For example, upon receiving the user input from the client device 102, the server device 104 may cause the search engine 120 to perform the selected predefined search query in the data repository 112. As another example, upon receiving the user input from the client device 102, the server device 104 may pass the selected predefined search query to the proper BAdl 210. The BAdl 210 may map the selected predefined search query to the reporting framework 200 which, in turn, identifies any responsive document(s) in the data repository 112. As yet another example, the search dispatcher 220 may be responsible for passing the selected predefined search query to the proper BAdl 210 for mapping.

Displaying, in optional step 450, results of the selected predefined search query in the GUI in a format specified by a results display declaration in the file. For example, the results may be displayed in the results listing area 302. The results display declaration 122 may specify that the return number, return date and return status attributes are displayed in the area 302. The results display declaration 122 may specify that the return number attributes are configured as links to the respective documents.

In some implementations, steps may be performed in a different order. For example, the step 410 can be performed immediately after step 430, or immediately before step 440. That is, the search query may be retrieved upon selection of the UUR.

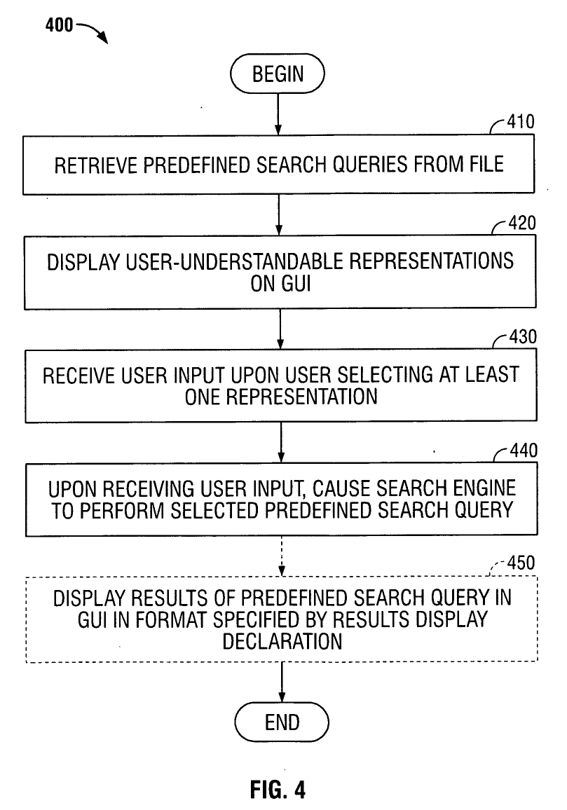

FIG. 5 is a block diagram of a computer system 500 that can be used in the operations described above, according to one embodiment. For example, the system 500 may be included in any or both of the server device 104 and the client device 102.

The system 500 includes a processor 510, a memory 520, a storage device 530 and an input/output device 540. Each of the components 510, 520, 530 and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 includes a display unit for displaying graphical user interfaces. For example, the input/output device 540 may display the GUI 300 shown in FIGS. 3A-C.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method to be performed in a computer system in which a search engine is used for searching a data repository, the method comprising:
retrieving predefined search queries from a file in a computer system, each of which predefined search queries can be used by a search engine to search a data repository;
displaying user-understandable representations of the predefined search queries on a graphical user interface for user selection;
receiving a user input upon a user selecting at least one of the displayed user-understandable representations; and
upon receiving the user input, causing the search engine to perform the selected predefined search query in the data repository.

2. The method of claim 1, wherein each of the predefined search queries is designed for retrieving a document stored in the data repository that has a predefined document type.

3. The method of claim 2, wherein the data repository includes multiple document types, and wherein retrieving the predefined search queries comprises accessing search query declarations stored in the file, each of the search query declarations being associated with one of the document types.

4. The method of claim 3, wherein at least one of the search query declarations lists an attribute that can be searched for the associated document type.

5. The method of claim 3, wherein at least one of the search query declarations lists values that are allowed in searching for the associated document type.

6. The method of claim 1, wherein retrieving the predefined search queries comprises retrieving from the file:
values that are allowed in searching for the associated document type; and
the user-understandable representations, which correspond to the values.

7. The method of claim 1, wherein each of the predefined search queries identify attributes that can be searched in the data repository.

8. The method of claim 1, wherein at least two of the user-understandable representations can be combined by the user.

9. The method of claim 8, wherein at least one of the at least two user-understandable representations is a dependent user-understandable representation that is displayed upon the user selecting the other of the at least two user-understandable representations.

10. The method of claim 8, wherein at least one of the at least two user-understandable representations adds a restriction to the selected predefined search query.

11. The method of claim 10, wherein the added restriction involves searching the data repository for a specific document type.

12. The method of claim 10, wherein the added restriction involves searching the data repository for data repository entries created during a specific time.

13. The method of claim 10, wherein the added restriction involves searching the data repository for data repository entries generated by a specific user.

14. The method of claim 1, further comprising displaying, in the graphical user interface, results of the selected predefined search query in a format specified by a results display declaration in the file.

15. The method of claim 14, wherein the results display declaration is retrieved from the file upon receiving the user input.

16. The method of claim 14, wherein the results display declaration indicates that specific attributes of the results are to be displayed in the graphical user interface.

17. The method of claim 16, wherein the search engine returns the specific attributes and other attributes upon performing the selected predefined query, further comprising removing the other attributes before displaying the results.

18. The method of claim 16, wherein the search engine returns only the specific attributes.

19. The method of claim 1, wherein the computer system includes multiple data repositories, and wherein the selected predefined search query is associated with at least one of the multiple data repositories.

20. The method of claim 1, wherein the search engine includes 1) a reporting framework that extracts information from the data repository and 2) several mapping programs associated with respective document types, wherein the mapping program associated with the selected predefined search query maps the query to the reporting framework.

21. The method of claim 20, wherein the computer system includes a search dispatcher that instantiates a proper one of the several mapping programs for the selected predefined search query.

22. The method of claim 1, wherein the user-understandable representations are displayed to the user as a guide to the predefined search queries, and wherein the user selects one of the user-understandable representations by typing the selected user-understandable representation into a field on the graphical user interface.

23. A computer program product tangibly embodied in an information carrier, the computer program product including instructions that, when executed, cause a processor to perform operations comprising:
retrieve predefined search queries from a file in a computer system, each of which predefined search queries can be used by a search engine to search a data repository;
display user-understandable representations of the predefined search queries on a graphical user interface for user selection;
receive a user input upon a user selecting at least one of the displayed user-understandable representations; and
upon receiving the user input, cause the search engine to perform the selected predefined search query in the data repository.

24. A computer program product tangibly embodied in an information carrier, the computer program product including instructions that, when executed, generate on a display device a graphical user interface for user selection of a predefined search query, the graphical user interface comprising:
a search query selection area in which user-understandable representations of predefined search queries can be displayed, which predefined search queries can be performed by a search engine in a data repository, wherein display of at least one of the user-understandable representations is dependent upon user selection of another of the user-understandable representations.

25. The computer program product of claim 24, wherein selecting the at least one user-understandable representation adds a restriction to the predefined search query of the other user-understandable representation.

26. The computer program product of claim 25, wherein the added restriction involves searching the data repository for a specific document type.

27. The computer program product of claim 25 wherein the added restriction involves searching the data repository for data repository entries created during a specific time.

28. The computer program product of claim 25, wherein the added restriction involves searching the data repository for data repository entries generated by a specific user.

29. The computer program product of claim 24, wherein the at least one user-understandable representation and the other user-understandable representation are drop down list box entries.
